(19) United States
(12) Patent Application Publication
(10) Pub. No.: US 2022/0236423 A1
(43) Pub. Date: Jul. 28, 2022

(54) INFORMATION ACQUISITION APPARATUS AND INFORMATION ACQUISITION METHOD

(71) Applicant: KABUSHIKI KAISHA TOSHIBA, Tokyo (JP)

(72) Inventors: Tenta SASAYA, Tokyo (JP); Toshiyuki ONO, Kawasaki (JP)

(73) Assignee: KABUSHIKI KAISHA TOSHIBA, Tokyo (JP)

(21) Appl. No.: 17/446,471

(22) Filed: Aug. 31, 2021

(30) Foreign Application Priority Data
Jan. 27, 2021 (JP) 2021-011127

(51) Int. Cl. G01S 17/894; G01S 17/26; G01S 7/487; G01S 7/4865; G01S 7/48

(52) U.S. Cl. CPC G01S 17/894; G01S 17/26; G01S 7/4802; G01S 7/4865; G01S 7/487

(57) ABSTRACT

According to one embodiment, an information acquisition apparatus includes an emitter, a detector and processing circuitry. The emitter is configured to emit light. The detector is configured to detect the light reflected by a target. The processing circuitry is configured to acquire a plurality of distance indexes, the distance indexes being based on time differences between emission and detection of the light, and generate distance information regarding a distance to the target based on a frequency distribution of the acquired distance indexes or a statistic calculated from the frequency distribution.

### CROSS-REFERENCE TO RELATED APPLICATIONS

This application is based upon and claims the benefit of priority from Japanese Patent Application No. 2021-011127, filed Jan. 27, 2021, the entire contents of which are incorporated herein by reference.

### FIELD

Embodiments described herein relate generally to an information acquisition apparatus and an information acquisition method.

### BACKGROUND

A technique that optically obtains information regarding a target, such as a distance to the target, is being researched and developed.

For example, with growth in autonomous driving and production automation in factories, and the like, use of ranging sensors that perform distance measurement to recognize humans or objects is spreading. Distance measurement techniques are generally divided into two types: passive imaging that performs distance measurement based on a feature of a red-green-blue (RGB) image, and active imaging that performs distance measurement based on response characteristics to light such as laser light. The active imaging is being put into practical use because measurement robust to ambient light is possible. Among the active imaging, a ranging sensor that performs distance measurement based on the time-of-flight (ToF) of light has attracted attention in recent years because the ranging sensor is excellent in respect of measurement time and distance measurement range. In ranging sensors based on the time-of-flight of light, a ranging sensor for short distance is referred to as a laser range finder (LRF), and a ranging sensor for long distance is referred to as light detection and ranging (LiDAR).

### BRIEF DESCRIPTION OF THE DRAWINGS

FIG. 1 is a diagram illustrating optical distance measurement;

FIG. 2 is a diagram illustrating a pulse form of emitted light, a pulse form of reflected light, and a distribution of detected light in the optical distance measurement;

FIG. 3 is a diagram illustrating bias errors of targets in the optical distance measurement;

FIG. 4 is a diagram illustrating histograms of measured distances obtained using the optical distance measurement;

FIG. 5 is a block diagram illustrating a hardware configuration example of an information acquisition apparatus according to an embodiment;

FIG. 6 is a block diagram illustrating a function configuration example of a distance measuring apparatus according to a first embodiment;

FIG. 7 is a flowchart illustrating a procedure example of distance measurement in the distance measuring apparatus illustrated in FIG. 6;

FIG. 8 is a block diagram illustrating a function configuration example of a distance measuring apparatus according to a second embodiment;

FIG. 9 is a flowchart illustrating a procedure example of processing in the distance measuring apparatus illustrated in FIG. 8;

FIG. 10 is a block diagram illustrating a function configuration example of an attribute estimation apparatus according to a third embodiment; and

FIG. 11 is a flowchart illustrating a procedure example of an attribute estimation in the attribute estimation apparatus illustrated in FIG. 10.

### DETAILED DESCRIPTION

According to one embodiment, an information acquisition apparatus includes an emitter, a detector and processing circuitry. The emitter is configured to emit light. The detector is configured to detect the light reflected by a target. The processing circuitry is configured to acquire a plurality of distance indexes, the distance indexes being based on time differences between emission and detection of the light, and generate distance information regarding a distance to the target based on a frequency distribution of the acquired distance indexes or a statistic calculated from the frequency distribution.

According to the embodiment, there is provided a technique that can optically obtain information regarding a target.

Hereinafter, embodiments will be described with reference to the accompanying drawings. The embodiments are directed to an information acquisition apparatus that obtains target information that is information regarding a target based on the time-of-flight (ToF) of light. In one embodiment, the target information includes at least one of distance information regarding a distance to a target and attribute information that indicates an attribute of the target.

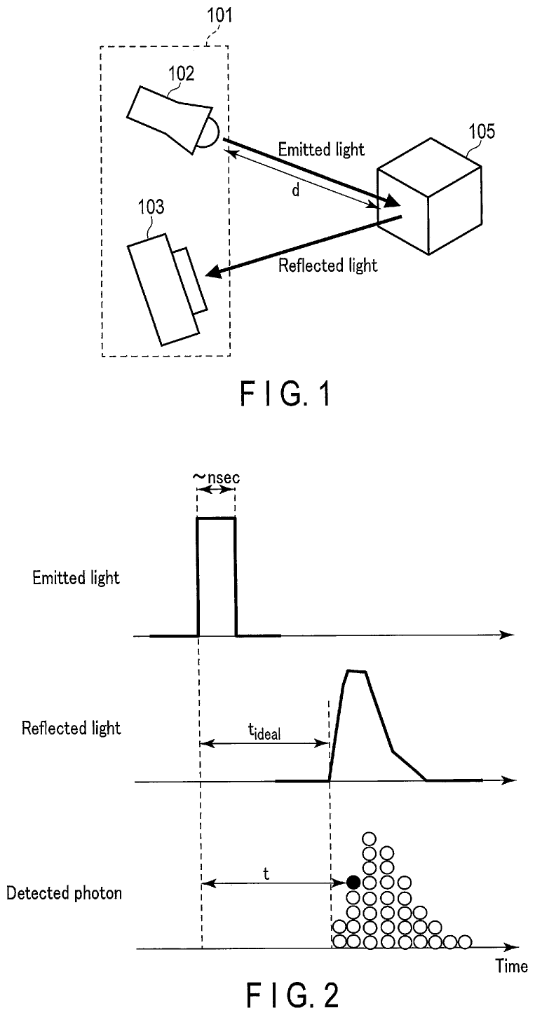

First, optical distance measurement that measures a distance based on the time-of-flight of light will be described with reference to FIGS. 1 to 4. In the distance measurement, a ranging sensor 101 that includes a laser 102 and a photodetector 103, as illustrated in FIG. 1, may be used. In the distance measurement, a light pulse from the laser 102 is emitted toward a target 105, the light pulse that is reflected by the target 105 is detected by the photodetector 103, and a distance between the ranging sensor 101 and the target 105 is calculated from a time difference between an emission time of the light pulse and a detection time of the reflected light pulse, according to the following Expression (1).

d=t·c/2 (1)

Here, d is a distance between the ranging sensor 101 and the target 105, t is a time difference between an emission time and a detection time, and c is the speed of light.

The laser 102 emits a rectangular light pulse with a time width of some nanoseconds, as illustrated in FIG. 2. The light pulse is deformed when the light pulse is reflected by the target 105. A method in which a time at which a photon is detected for the first time by the photodetector 103 is considered as a detection time, and a time difference is calculated is generally used. Since detection of a photon is a probability process according to a shape (distribution) of reflected light, a detection time varies by a width of the distribution, and a variation in a measured distance occurs (repetition error). Further, there are a method in which a time at which a photon of a quantity of light that exceeds a threshold is detected is considered as a detection time, and a method in which two or more photons are detected, and a time at which an accumulated quantity of light or an average quantity of light exceeds a threshold is considered as a detection time. However, any of the methods causes a variation in a measured distance, due to similar reasons. There is also a method in which a shape of reflected light is determined and then a time difference is calculated. However, a circuit logic is complicated.

A shape of reflected light depends on attributes of a target, such as materials and colors. Therefore, even if actual distances from a ranging sensor to targets are the same, distortion to the actual distance (bias error) occurs depending on each of the targets.

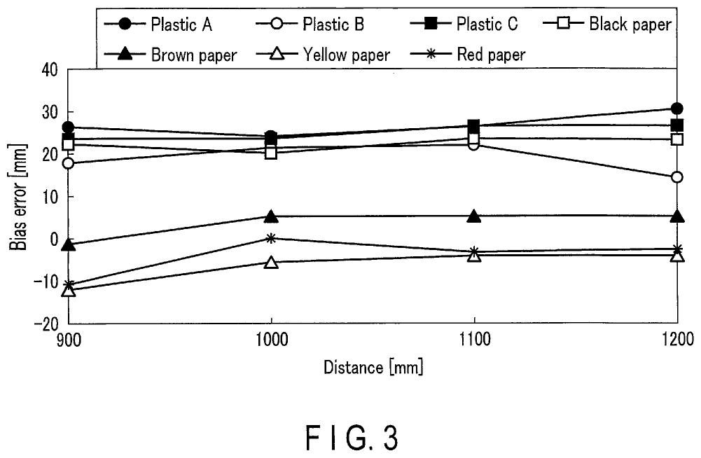

FIG. 3 schematically illustrates a bias error of each target. In FIG. 3, a horizontal axis represents actual distance, and a vertical axis represents bias error. A bias error represents a value given by subtracting an actual distance from a measured distance. As illustrated in FIG. 3, when an actual distance is approximately 1 meter, a bias error of plus or minus a few centimeters occurs. Plastic A, plastic B, and plastic C are different types of plastic, and have bias errors of approximately 2 centimeters. A bias error of black paper is approximately 2 centimeters. On the other hand, bias errors of yellow paper, brown paper, and red paper are relatively small.

The repetition error can be decreased by averaging a plurality of times of measurement results, but the bias error cannot be dealt with by averaging because the bias error corresponds to distortion of an average distance.

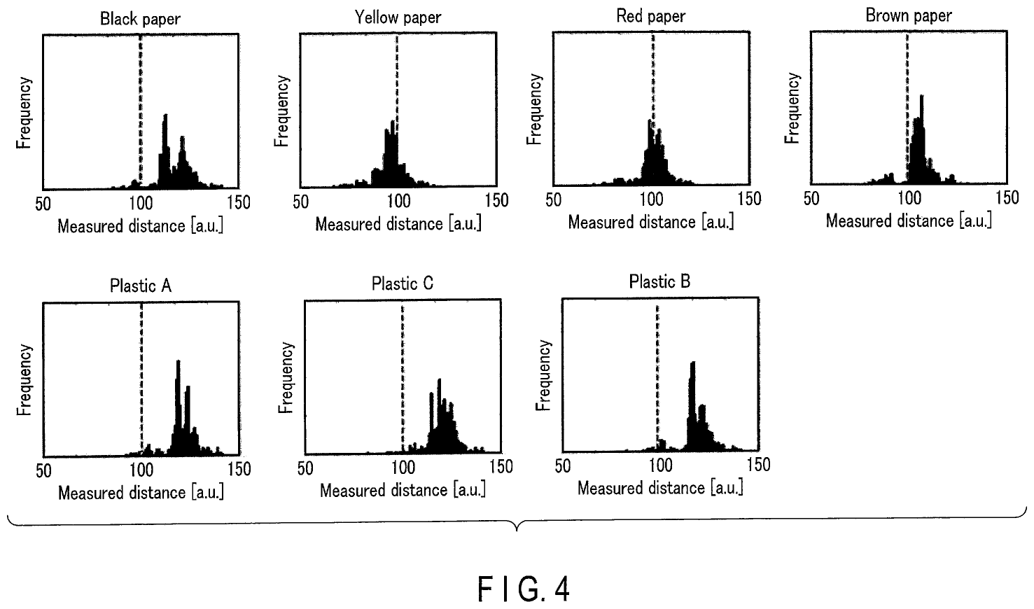

FIG. 4 schematically illustrates histograms of measured distances obtained using the optical distance measurement described above. In each graph of FIG. 4, a horizontal axis represents measured distance, a vertical axis represents frequency, and a broken line represents an actual distance. The measured distance is acquired by the ranging sensor 101 in a state where a target is disposed the actual distance away from the ranging sensor 101. As illustrated in FIG. 4, a frequency distribution of measured distances depends on attributes of a target. More specifically, a relationship between a frequency distribution of measured distances and an actual distance depends on attributes of a target.

Optical distance measurement according to an embodiment sequentially emits light pulses, obtains time differences for the respective light pulses, calculates distances from the respective time differences according to Expression (1) described above, and obtains a measured distance based on a frequency distribution of the calculated distances and preliminarily prepared information that indicates a relationship between a frequency distribution and a distance. Due to this, the bias error can be decreased. Therefore, more precise distance measurement becomes possible.

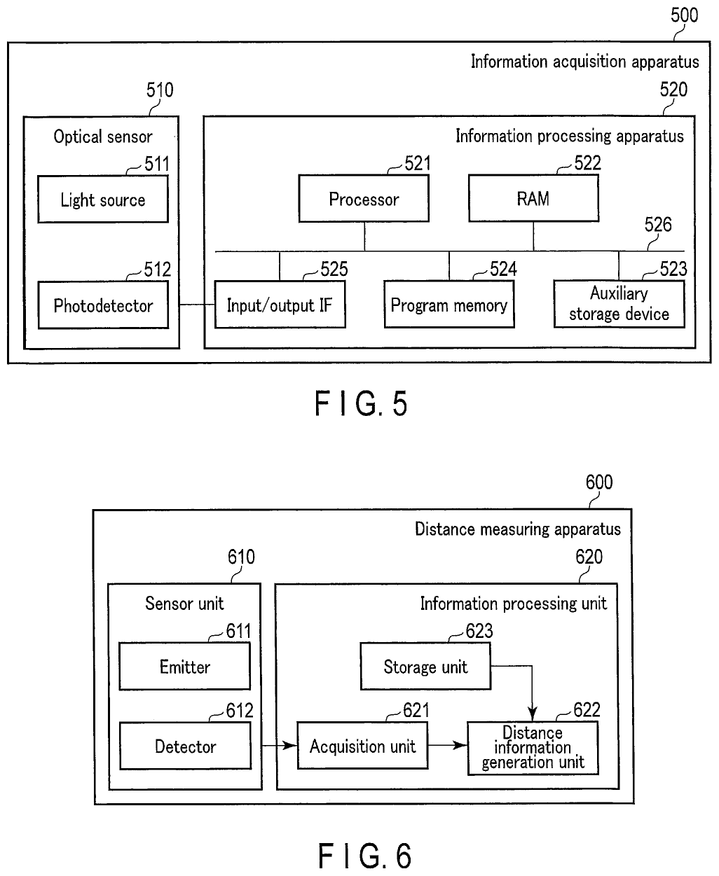

FIG. 5 schematically illustrates an example of hardware configuration of an information acquisition apparatus 500 according to one embodiment. As illustrated in FIG. 5, the information acquisition apparatus 500 includes an optical sensor 510 and an information processing apparatus 520.

The optical sensor 510 includes a light source 511 and a photodetector 512. The light source 511 is configured to generate and emit light pulses. As the light source 511, a pulse laser diode, for example, may be used. The photodetector 512 is configured to detect light pulses that are emitted by the light source 511 and are reflected by a target. As the photodetector 512, a photodiode, for example, may be used.

The information processing apparatus 520 includes a processor 521, a random access memory (RAM) 522, an auxiliary storage device 523, a program memory 524, an input/output interface 525, and a bus 526. The processor 521 is connected to the RAM 522, the auxiliary storage device 523, the program memory 524, and the input/output interface 525 through the bus 526, and exchanges signals with the RAM 522, the auxiliary storage device 523, the program memory 524, and the input/output interface 525.

The processor 521 includes a general-purpose circuit, such as a central processing unit (CPU) or a graphics processing unit (GPU). The RAM 522 is used as a working memory by the processor 521. The RAM 522 includes a volatile memory, such as a synchronous dynamic RAM (SDRAM). The auxiliary storage device 523 stores data. The auxiliary storage device 523 includes a non-volatile memory, such as a flash memory. The program memory 524 stores programs, such as an information acquisition program, executed by the processor 521. Each of the programs includes computer-executable instructions. The program memory 524 may be a read only memory (ROM). Alternatively, some regions of the auxiliary storage device 523 may be used as the program memory 524.

The processor 521 loads programs stored in the program memory 524 onto the RAM 522, and interprets and executes the programs. When the information acquisition program is executed by the processor 521, the information acquisition program causes the processor 521 to perform processing that will be described below in each of first to third embodiments.

The programs stored in a computer-readable recording medium may be provided to the information processing apparatus 520. In this case, the information processing apparatus 520 includes a drive that reads data from the recording medium, and acquires the programs from the recording medium. Examples of the recording medium includes a magnetic disk, optical discs (a compact disc read-only memory (CD-ROM), a compact disc-recordable (CD-R), a digital versatile disc read only memory (DVD-ROM), a digital versatile disc-recordable (DVD-R), and the like), magneto-optical discs (a magneto-optical disc (MO) and the like), and a semiconductor memory. Alternatively, the programs may be distributed through a network. Specifically, the programs may be stored in a server on a network, and the information processing apparatus 520 may download the programs from the server.

The input/output interface 525 includes an interface for connecting the optical sensor 510. The processor 521 communicates with the optical sensor 510 through the input/output interface 525. The processor 521 transmits a control signal to the optical sensor 510 through the input/output interface 525. The optical sensor 510 operates according to the control signal from the processor 521. The processor 521 receives a time difference signal that indicates a time difference between emission and detection of a light pulse, that is to say a difference between an emission time of a light pulse and a detection time of a reflected light pulse, from the optical sensor 510 through the input/output interface 525. The emission time indicates a time at which the light source 511 emits a light pulse, and the detection time indicates a time at which the photodetector 512 detects the light pulse reflected by a target. Alternatively, the processor 521 may receive a time signal that indicates an emission time of a light pulse and a detection time of a reflected light pulse from the optical sensor 510 through the input/output interface 525, and calculate a time difference between emission and detection of the light pulse from the time signal.

The information processing apparatus 520 may include a dedicated circuit, instead of or in addition to the general-purpose circuit. Examples of the dedicated circuit include an application specific integrated circuit (ASIC) and a field programmable gate array (FPGA).

### First Embodiment

In a first embodiment, target information includes distance information on a target.

FIG. 6 schematically illustrates a distance measuring apparatus 600 according to the first embodiment. As illustrated in FIG. 6, the distance measuring apparatus 600 includes a sensor unit 610 and an information processing unit 620.

The sensor unit 610 includes an emitter 611 configured to emit a light pulse, and a detector 612 configured to detect a light pulse that is emitted by the emitter 611 and is reflected by a target. The emitter 611 is implemented by the light source 511 illustrated in FIG. 5. The detector 612 is implemented by the photodetector 512 illustrated in FIG. 5. The sensor unit 610 transmits a time difference signal that indicates a time difference between emission and detection of a light pulse to the information processing unit 620. The time difference indicates a period of time from the emitter 611 emitting a light pulse to the detector 612 detecting the light pulse reflected by a target. The sensor unit 610 sequentially emits light pulses, and thus the information processing unit 620 receives time difference signals for the respective light pulses.

The information processing unit 620 includes an acquisition unit 621, a distance information generation unit 622, and a storage unit 623. The acquisition unit 621 and the distance information generation unit 622 are implemented by the processor 521 illustrated in FIG. 5. The storage unit 623 is implemented by the auxiliary storage device 523 or the program memory 524 illustrated in FIG.

The acquisition unit 621 receives a plurality of time difference signals from the sensor unit 610, and acquires a plurality of distances calculated based on a plurality of time differences indicated by the plurality of received time difference signals. The acquisition unit 621 performs a calculation that calculates a distance from a time difference, for each of the time difference signals. The distance may be calculated according to, for example, Expression (1) described above.

The distance information generation unit 622 generates distance information on a target based on a frequency distribution of a plurality of distances acquired by the acquisition unit 621 or a statistic calculated from the frequency distribution, and outputs the generated distance information on the target. The distance information indicates a distance to a target. Specifically, the distance information indicates a measurement result of a distance between a target and the distance measuring apparatus 600 (specifically, the sensor unit 610).

In the case where the distance information generation unit 622 generates distance information based on a frequency distribution, the storage unit 623 may store reference information (for example, a lookup table) in which a plurality of distances and a plurality of frequency distributions are associated with each other. The reference information is preliminarily generated using an optical sensor of a type similar to the optical sensor 510. To generate the reference information, for example, processing that performs distance measurement a plurality of times using the optical sensor in a state where a target is disposed a specific distance away from the optical sensor to obtain a frequency distribution of the measurement results is performed to a plurality of distances. The storage unit 623 includes reference information regarding one or more types of targets. As illustrated in FIG. 4, frequency distributions of plastic A and plastic B show similar tendencies. Therefore, if the storage unit 623 stores reference information regarding the plastic A, reference information regarding the plastic B may not be stored in the storage unit 623. In other words, reference information on all targets that may be measurement targets is not needed. Hereinafter, a frequency distribution of a plurality of distances acquired by the acquisition unit 621 is also referred to as a target frequency distribution, and a frequency distribution included in reference information is also referred to as a reference frequency distribution.

The distance information generation unit 622 obtains a distance corresponding to a target frequency distribution, as distance information, from reference information stored in the storage unit 623. Specifically, the distance information generation unit 622 selects at least one reference frequency distribution similar to a target frequency distribution from the reference frequency distributions, and generates distance information based on at least one distance associated with the selected at least one reference frequency distribution. For example, the distance information generation unit 622 may calculate degrees of similarity between a target frequency distribution and the reference frequency distributions by regression based on the k-nearest neighbors algorithm, select a reference frequency distribution that has the highest degree of similarity, and obtain a distance associated with the selected reference frequency distribution, as distance information. Alternatively, the distance information generation unit 622 may select the predetermined number of reference frequency distributions in order of high degree of similarity, and obtain a weighted average of distances associated with the selected reference frequency distributions, as distance information.

In the case where the distance information generation unit 622 generates distance information based on a statistic, the storage unit 623 may store reference information in which a plurality of distances and a plurality of statistics are associated with each other. The reference information is preliminarily generated using an optical sensor of a type similar to the optical sensor 510. To generate the reference information, for example, processing that performs distance measurement a plurality of times using the optical sensor in a state where a target is disposed a specific distance away from the optical sensor to calculate a statistic from a frequency distribution of the measurement results is performed to a plurality of distances. The storage unit 623 includes reference information regarding one or more types of targets. The statistic includes at least one of an average, a variance, a standard deviation, a median, a minimum, a maximum, a mode, skewness, and kurtosis. Preferably, the statistic includes at least one of an average, a median, and a mode, and at least one of a variance, a standard deviation, skewness, and kurtosis. Hereinafter, a statistic calculated from a target frequency distribution is also referred to as a target statistic, and a statistic included in reference information is also referred to as a reference statistic.

The distance information generation unit 622 obtains a distance corresponding to a target statistic, as distance information, from reference information stored in the storage unit 623. A method of obtaining a distance corresponding to a target statistic is similar to the above-described method of obtaining a distance corresponding to a target frequency distribution. Therefore, the detailed description thereof will be omitted.

The distance information generation unit 622 may obtain a correction value based on a target frequency distribution, and generate distance information based on a plurality of distances acquired by the acquisition unit 621 and the obtained correction value. In this case, the storage unit 623 may store reference information in which a plurality of correction values and a plurality of reference frequency distributions are associated with each other. The reference information is preliminarily generated using an optical sensor of a type similar to the optical sensor 510. To generate the reference information, for example, processing that performs distance measurement a plurality of times using the optical sensor in a state where a target is disposed a specific distance away from the optical sensor to obtain a frequency distribution of the measurement results and calculate a correction value based on the specific distance and the measurement results is performed to a plurality of distances. The correction value may be defined as a correction quantity. The correction value may be, for example, a difference between a representative distance calculated from the measurement results and a specific distance. The representative distance may be any of an average, a median, and a mode of the frequency distribution of the measurement results. Alternatively, the correction value may be defined as a coefficient. The correction value may be, for example, a value given by dividing the representative distance by the specific distance, or a value given by dividing the specific distance by the representative distance.

The distance information generation unit 622 may obtain a correction value corresponding to a target frequency distribution from reference information stored in the storage unit 623, and generate distance information based on a plurality of distances acquired by the acquisition unit 621 and the correction value. A method of obtaining a correction value corresponding to a target frequency distribution is similar to the above-described method of obtaining a distance corresponding to a target frequency distribution. Therefore, the detailed description thereof will be omitted. In the case where a correction value is a correction quantity, the distance information generation unit 622 generates distance information by, for example, calculating a representative distance from a plurality of distances acquired by the acquisition unit 621, and adding or subtracting the correction value to or from the calculated representative distance. In the case where a correction value is a coefficient, the distance information generation unit 622 generates distance information by, for example, calculating a representative distance from a plurality of distances acquired by the acquisition unit 621, and multiplying or dividing the calculated representative distance by the correction value.

The distance information generation unit 622 may obtain a correction value based on a target statistic, and generate distance information based on a plurality of distances acquired by the acquisition unit 621 and the correction value. In this case, the storage unit 623 may store reference information in which a plurality of correction values and a plurality of reference statistics are associated with each other. The reference information is preliminarily generated using an optical sensor of a type similar to the optical sensor 510. To generate the reference information, for example, processing that performs distance measurement a plurality of times using the optical sensor in a state where a target is disposed a specific distance away from the optical sensor to calculate a statistic from a frequency distribution of the measurement results and calculate a correction value based on the specific distance and the measurement results is performed to a plurality of distances.

The distance information generation unit 622 may obtain a correction value corresponding to a target statistic from reference information stored in the storage unit 623, and generate distance information based on a plurality of distances acquired by the acquisition unit 621 and the correction value. A method of obtaining a correction value corresponding to a target statistic is similar to the above-described method of obtaining a distance corresponding to a target frequency distribution. Therefore, the detailed description thereof will be omitted.

Instead of reference information such as a lookup table, the distance information generation unit 622 may use a model obtained by machine learning to generate distance information. In this case, the storage unit 623 stores one or more parameter included in a trained model. As a machine learning algorithm, a neural network, a support vector machine (SVM), or a random forest, for example, may be used.

A model may be configured to output a distance when a frequency distribution is input into the model, and the above-described reference information in which a plurality of distances and a plurality of frequency distributions are associated with each other may be used as training data to train the model. The distance information generation unit 622 inputs a target frequency distribution into a trained model, and obtains a distance output from the trained model, as distance information.

Alternatively, a model may be configured to output a correction value when a frequency distribution is input into the model, and the above-described reference information in which a plurality of correction values and a plurality of frequency distributions are associated with each other may be used as training data to train the model. The distance information generation unit 622 may input a target frequency distribution into a trained model, obtain a correction value output from the trained model, and generate distance information based on a plurality of distances acquired by the acquisition unit 621 and the correction value.

Alternatively, a model may be configured to output a distance when a statistic is input into the model, and the above-described reference information in which a plurality of distances and a plurality of statistics are associated with each other may be used as training data to train the model. The distance information generation unit 622 inputs a target statistic into a trained model, and obtains a distance output from the trained model, as distance information.

Alternatively, a model may be configured to output a correction value when a statistic is input into the model, and the above-described reference information in which a plurality of correction values and a plurality of Statistics are associated with each other may be used as training data to train the model. The distance information generation unit 622 may input a target statistic into a trained model, obtain a correction value output from the trained model, and generate distance information based on a plurality of distances acquired by the acquisition unit 621 and the correction value.

Note that the distance information generation unit 622 may generate distance information on a target based on both a target frequency distribution and a target statistic.

Next, operation of the distance measuring apparatus 600 will be described.

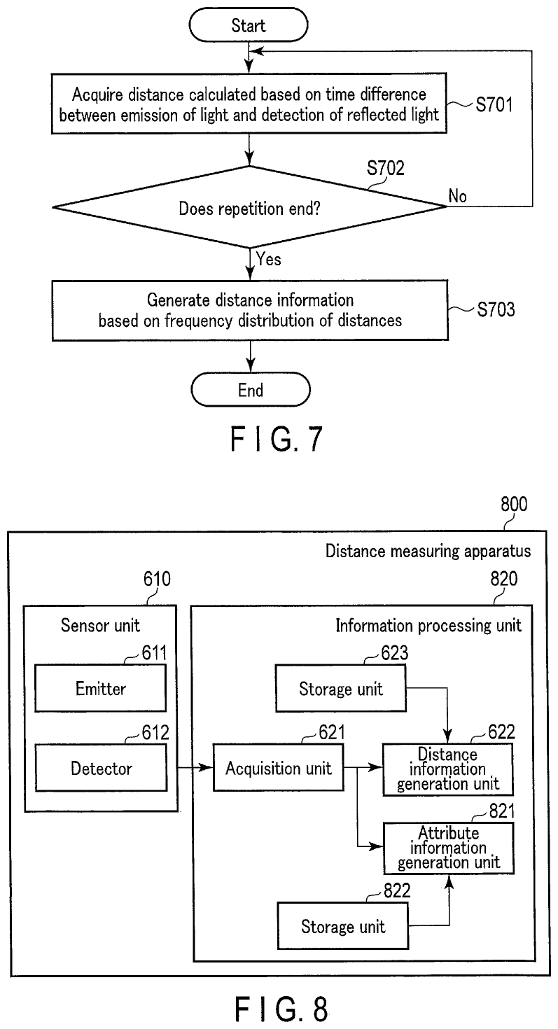

FIG. 7 schematically illustrates a procedure example of processing executed by the distance measuring apparatus 600. In step S701 of FIG. 7, the acquisition unit 621 acquires a distance calculated based on a time difference between emission and detection of a light pulse. For example, the emitter 611 of the sensor unit 610 emits a light pulse to a target, and the detector 612 of the sensor unit 610 detects the light pulse reflected by the target. The sensor unit 610 transmits a time difference signal that indicates a time difference between an emission time of the light pulse and a detection time of the reflected light pulse to the acquisition unit 621. The acquisition unit 621 calculates a distance from the time difference indicated by the received time difference signal, according to Expression (1) described above.

In step S702, it is determined whether or not the number of execution times of the processing indicated in step S701 reaches the number of repetition times that is predetermined (for example, 100 times). If the number of execution times does not reach the number of repetition times (step S702; No), the processing returns to step S701, and the acquisition unit 621 acquires a distance.

If the number of execution times reaches the number of repetition times (step S702; Yes), the processing proceeds to step S703. At this time, distances of the number of repetition times (for example, 100 distances) are acquired.

In step S703, the distance information generation unit 622 generates distance information on the target based on a target frequency distribution that is a frequency distribution of the plurality of distances acquired by the acquisition unit 621 or a target statistic that is a statistic calculated from the target frequency distribution. In an example in which the storage unit 623 stores reference information in which a plurality of distances and a plurality of reference frequency distributions are associated with each other, the distance information generation unit 622 may identify a reference frequency distribution that is the most similar to the target frequency distribution among the reference frequency distributions, and obtain a distance associated with the identified reference frequency distribution as the distance information on the target. In an example in which the storage unit 623 stores reference information in which a plurality of distances and a plurality of reference statistics are associated with each other, the distance information generation unit 622 may identify a reference statistic that is the most similar to the target statistic among the reference statistics, and obtain a distance associated with the identified reference statistic as the distance information on the target. In an example in which the storage unit 623 stores reference information in which a plurality of correction values and a plurality of reference frequency distributions are associated with each other, the distance information generation unit 622 may identify a reference frequency distribution that is the most similar to the target frequency distribution among the reference frequency distributions, obtain a correction value associated with the identified reference frequency distribution, and generate the distance information on the target based on the distances acquired by the acquisition unit 621 and the obtained correction value. In an example in which the storage unit 623 stores reference information in which a plurality of correction values and a plurality of reference statistics are associated with each other, the distance information generation unit 622 may identify a reference statistic that is the most similar to the target statistic among the reference statistics, obtain a correction value associated with the identified reference statistic, and generate the distance information on the target based on the distances acquired by the acquisition unit 621 and the obtained correction value. Alternatively, the distance information generation unit 622 may input input data including the target frequency distribution or the target statistic into a trained model, and obtain a distance output from the trained model as the distance information on the target. Alternatively, the distance information generation unit 622 may input input data including the target frequency distribution or the target statistic into a trained model, obtain a correction value output from the trained model, and generate the distance information on the target based on the distances acquired by the acquisition unit 621 and the obtained correction value.

As described above, the distance measuring apparatus 600 includes the emitter 611 that emits light, the detector 612 that detects light emitted by the emitter 611 and reflected by a target, the acquisition unit 621 that acquires distances calculated based on respective time differences between the emission and the detection of light, and the distance information generation unit 622 that generates distance information on the target based on a frequency distribution of the distances or a statistic calculated from the frequency distribution. Due to this, the bias error can be decreased. As the result, distance measurement can be more precisely performed.

### Second Embodiment

In a second embodiment, target information includes distance information on a target and attribute information on the target.

FIG. 8 schematically illustrates a distance measuring apparatus 800 according to the second embodiment. In FIG. 8, elements similar to the elements illustrated in FIG. 6 are denoted by similar reference signs, and the redundant descriptions will be appropriately omitted.

As illustrated in FIG. 8, the distance measuring apparatus 800 includes a sensor unit 610 and an information processing unit 820. The information processing unit 820 includes an acquisition unit 621, a distance information generation unit 622, a storage unit 623, an attribute information generation unit 821, and a storage unit 822. The information processing unit 820 corresponds to the information processing unit 620 illustrated in FIG. 6 to which the attribute information generation unit 821 and the storage unit 822 are added. The attribute information generation unit 821 is implemented by the processor 521 illustrated in FIG. 5. The storage unit 822 is implemented by the auxiliary storage device 523 or the program memory 524 illustrated in FIG. 5.

The attribute information generation unit 821 generates and outputs attribute information on a target based on a target frequency distribution or a target statistic. The attribute information is information that indicates an attribute of a target. The attribute may include a material. Examples of the material include plastic and paper. The plastic may refer to types of plastic, such as the plastic A, the plastic B, and the plastic C described above with reference to FIGS. 3 and 4. Further, the attribute may include characteristics that relate to light reflection. Examples of the characteristics that relate to light reflection include a reflectance, a refractive index, a transmittance, an attenuation coefficient, an absorption coefficient, and a cross section. The attribute may include at least one of a reflectance, a refractive index, a transmittance, an attenuation coefficient, an absorption coefficient, and a cross section.

In the case where the attribute information generation unit 821 generates attribute information on a target based on a target frequency distribution, the storage unit 822 may store reference information in which attribute information and a plurality of reference frequency distributions are associated with each other. The reference information is preliminarily generated using an optical sensor of a type similar to the optical sensor 510. To generate the reference information, for example, processing that performs distance measurement a plurality of times using the optical sensor in a state where a target is disposed a specific distance away from the optical sensor to obtain a frequency distribution of the measurement results is performed to a plurality of targets that have different attributes.

The attribute information generation unit 821 may select at least one reference frequency distribution similar to a target frequency distribution from reference frequency distributions included in reference information, and generate attribute information on a target based on attribute information associated with the selected at least one reference frequency distribution. For example, the attribute information generation unit 821 calculates degrees of similarity between a target frequency distribution and the reference frequency distributions by regression based on the k-nearest neighbors algorithm, selects a reference frequency distribution that has the highest degree of similarity, and obtains attribute information associated with the selected reference frequency distribution, as attribute information on a target. Alternatively, the attribute information generation unit 821 may select the predetermined number of reference frequency distributions in order of high degree of similarity, and generate attribute information on a target based on attribute information associated with the selected reference frequency distributions. Attribute information output by the attribute information generation unit 821 may include, for example, a set of attribute information associated with selected reference frequency distributions and degrees of similarity.

In the case where the attribute information generation unit 821 generates attribute information on a target based on a target statistic, the storage unit 822 may store reference information in which attribute information and a plurality of reference statistics are associated with each other. The generation of reference information and the generation of attribute information on a target are similar to the generation of reference information and the generation of attribute information on a target that are described above. Therefore, the detailed descriptions will be omitted.

Instead of reference information, the attribute information generation unit 821 may use a model obtained by machine learning to generate attribute information on a target. In this case, the storage unit 822 stores one or more parameter included in a trained model. As a machine learning algorithm, a neural network, an SVM, or a random forest, for example, may be used.

For example, a model may be configured to output attribute information when a frequency distribution is input into the model, and the above-described reference information in which attribute information and a plurality of reference frequency distributions are associated with each other may be used as training data to train the model. The attribute information generation unit 821 inputs a target frequency distribution into a trained model, and obtains attribute information output from the trained model, as attribute information on a target.

Alternatively, a model may be configured to output attribute information when a statistic is input into the model, and the above-described reference information in which attribute information and a plurality of reference statistics are associated with each other may be used as training data to train the model. The attribute information generation unit 821 inputs a target statistic into a trained model, and obtains attribute information output from the trained model, as attribute information on a target.

Note that the attribute information generation unit 821 may generate attribute information on a target based on both a target frequency distribution and a target statistic.

Next, operation of the distance measuring apparatus 800 will be described.

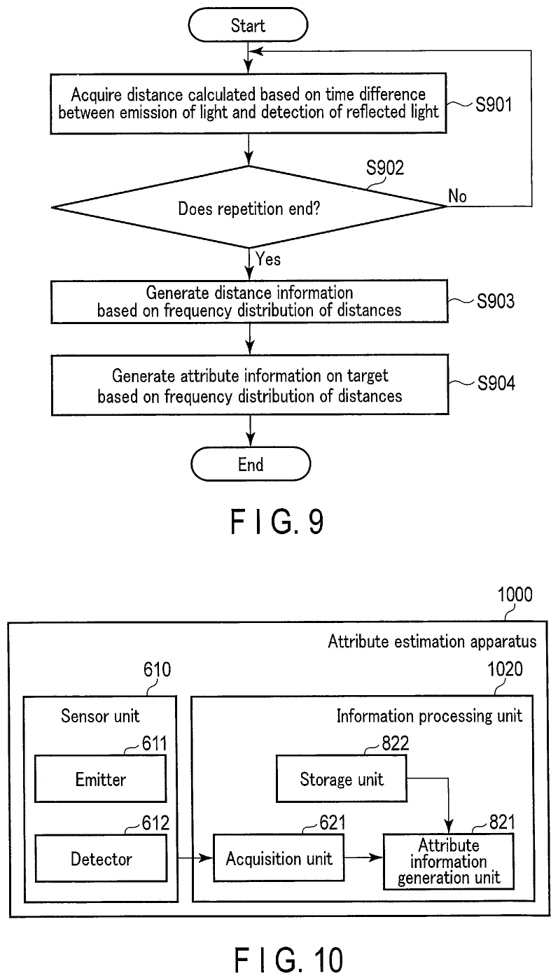

FIG. 9 schematically illustrates a procedure example of processing executed by the distance measuring apparatus 800. Processing of steps S901, S902, and S903 illustrated in FIG. 9 are similar to the processing of steps S701, S702, and S703 illustrated in FIG. 7. Therefore, detailed descriptions of the processing of steps S901, S902, and S903 will be omitted.

In step S901 of FIG. 9, the acquisition unit 621 acquires a distance calculated based on a time difference between emission and detection of light. In step S902, it is determined whether or not the number of execution times of the processing indicated in step S901 reaches the number of repetition times. If the number of execution times does not reach the number of repetition times (step S902; No), the processing returns to step S901, and the acquisition unit 621 acquires a distance.

If the number of execution times reaches the number of repetition times (step S902; Yes), the processing proceeds to step S903. In step S903, the distance information generation unit 622 generates distance information on a target based on a target frequency distribution that is a frequency distribution of the plurality of distances acquired by the acquisition unit 621, or a target statistic that is a statistic calculated from the target frequency distribution.

In step S904, the attribute information generation unit 821 generates attribute information on the target, based on the target frequency distribution or the target statistic. In an example in which the storage unit 822 stores reference information in which attribute information and a plurality of reference frequency distributions are associated with each other, the attribute information generation unit 821 may identify a reference frequency distribution that is the most similar to a target frequency distribution among the reference frequency distributions, and obtain attribute information associated with the identified reference frequency distribution, as the attribute information on the target. In an example in which the storage unit 822 stores reference information in which attribute information and a plurality of reference statistics are associated with each other, the attribute information generation unit 821 may identify a reference statistic that is the most similar to a target statistic among the reference statistics, and obtain attribute information associated with the identified reference statistic, as the attribute information on the target. Alternatively, the attribute information generation unit 821 may input input data that includes a target frequency distribution or a target statistic into a trained model, and obtain attribute information output from the trained model, as the attribute information on the target.

As described above, the distance measuring apparatus 800 includes the emitter 611 that emits light, the detector 612 that detects light emitted by the emitter 611 and reflected by a target, the acquisition unit 621 that acquires distances calculated based on respective time differences between the emission and the detection of light, the distance information generation unit 622 that generates distance information on the target based on a frequency distribution of the distances or a statistic calculated from the frequency distribution, and the attribute information generation unit 821 that generates attribute information on the target based on the frequency distribution of the distances or the statistic calculated from the frequency distribution. Due to this, more precise distance measurement can be performed, and the attribute of the target can be estimated.

### Third Embodiment

In a third embodiment, target information includes attribute information on a target.

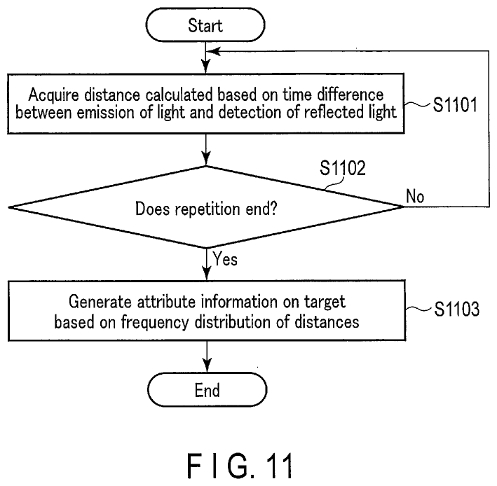

FIG. 10 schematically illustrates an attribute estimation apparatus 1000 according to the third embodiment. In FIG. 10, elements similar to the elements illustrated in FIG. 6 or 8 are denoted by similar reference signs, and the redundant descriptions will be appropriately omitted.

As illustrated in FIG. 10, the attribute estimation apparatus 1000 includes a sensor unit 610 and an information processing unit 1020. The information processing unit 1020 includes an acquisition unit 621, an attribute information generation unit 821, and a storage unit 822. The information processing unit 1020 corresponds to the information processing unit 820 illustrated in FIG. 8 from which the distance information generation unit 622 and the storage unit 623 are deleted.

FIG. 11 schematically illustrates a procedure example of processing executed by the attribute estimation apparatus 1000. Processing of steps S1101, S1102, and S1103 illustrated in FIG. 11 are similar to the processing of steps S701 and S702 illustrated in FIG. 7 and step S904 illustrated in FIG. 9. Therefore, the detailed descriptions thereof will be omitted.

In step S1101 of FIG. 11, the acquisition unit 621 acquires a distance calculated based on a time difference between emission and detection of light. In step S1102, it is determined whether or not the number of execution times of the processing indicated in step S1101 reaches the number of repetition times. If the number of execution times does not reach the number of repetition times (step S1102; No), the processing returns to step S1101, and the acquisition unit 621 acquires a distance.

If the number of execution times reaches the number of repetition times (step S1102; Yes), the processing proceeds to step S1103. In step S1103, the attribute information generation unit 821 generates attribute information on a target based on a target frequency distribution that is a frequency distribution of the plurality of distances acquired by the acquisition unit 621, or a target statistic that is a statistic calculated from the target frequency distribution.

As described above, the attribute estimation apparatus 1000 includes the emitter 611 that emits light, the detector 612 that detects light emitted by the emitter 611 and reflected by a target, the acquisition unit 621 that acquires distances calculated based on respective time differences between the emission and the detection of light, and the attribute information generation unit 821 that generates attribute information on the target based on a frequency distribution of the plurality of distances or a statistic calculated from the frequency distribution. Due to this, the attribute of the target can be estimated.

In each of the embodiments described above, the acquisition unit 621 acquires a distance calculated based on a time difference between emission and detection of light. The distance is an example of a distance index based on a time difference. The distance index refer to a distance itself or any index from which a distance can be derived. A distance index based on a time difference may be, for example, a time difference itself. In this case, the distance information generation unit 622 obtains a time difference based on a frequency distribution of a plurality of time differences acquired by the acquisition unit 621 or a statistic calculated from the frequency distribution. For example, the storage unit 623 stores reference information in which a plurality of time differences and a plurality of reference frequency distributions are associated with each other, and the distance information generation unit 622 obtains a time difference corresponding to a frequency distribution of a plurality of time differences acquired by the acquisition unit 621 from the reference information stored in the storage unit 623. Distance information output by the distance information generation unit 622 may be distance information that indicates an obtained time difference. Alternatively, the distance information generation unit 622 may calculate a distance from an obtained time difference according to Expression (1) described above, and output distance information that indicates the calculated distance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information acquisition apparatus comprising:
an emitter configured to emit light;
a detector configured to detect the light reflected by a target; and
processing circuitry configured to:
acquire a plurality of distance indexes, the distance indexes being based on time differences between emission and detection of the light; and
generate distance information regarding a distance to the target based on a frequency distribution of the acquired distance indexes or a statistic calculated from the frequency distribution.

2. The information acquisition apparatus according to claim 1, wherein the processing circuitry is configured to:
obtain a distance index corresponding to the frequency distribution of the acquired distance indexes or the statistic calculated from the frequency distribution from reference information in which a plurality of distance indexes is associated with a plurality of frequency distributions or a plurality of statistics; and
generate the distance information based on the obtained distance index.

3. The information acquisition apparatus according to claim 1, further comprising a memory coupled to the processor, the memory being configured to store a trained model configured to output a distance index when a frequency distribution or a statistic is input into the trained model, wherein
the processing processor is configured to:
input the frequency distribution of the acquired distance indexes or the statistic calculated from the frequency distribution into the trained model to obtain a distance index output from the trained model; and
generate the distance information based on the obtained distance index.

4. The information acquisition apparatus according to claim 1, wherein the processing circuitry is configured to:
obtain a correction value corresponding to the frequency distribution of the acquired distance indexes or the statistic calculated from the frequency distribution from reference information in which a plurality of correction values is associated with a plurality of frequency distributions or a plurality of statistics; and
generate the distance information based on the acquired distance indexes and the obtained correction value.

5. The information acquisition apparatus according to claim 1, further comprising a memory coupled to the processor, the memory being configured to store a trained model configured to output a correction value when a frequency distribution or a statistic is input into the trained model, wherein
the processing circuitry is configured to:
input the frequency distribution of the acquired distance indexes or the statistic calculated from the frequency distribution into the trained model to obtain a correction value output from the trained model; and
generate the distance information based on the acquired distance indexes and the obtained correction value.

6. The information acquisition apparatus according to claim 1, wherein
the processing circuitry is configured to generate the distance information based on the statistic calculated from the frequency distribution, and
the statistic calculated from the frequency distribution includes at least one of an average, a variance, a standard deviation, a median, a minimum, a maximum, a mode, skewness, and kurtosis of the frequency distribution.

7. The information acquisition apparatus according to claim 6, wherein
the statistic calculated from the frequency distribution includes at least one of the average, the median, and the mode, and at least one of the variance, the standard deviation, the skewness, and the kurtosis.

8. The information acquisition apparatus according to claim 1, wherein,
the processing circuitry is configured to generate attribute information indicating an attribute of the target based on the frequency distribution of the acquired distance indexes or the statistic calculated from the frequency distribution.

9. The information acquisition apparatus according to claim 8, wherein
the processing circuitry is configured to obtain attribute information corresponding to the frequency distribution of the acquired distance indexes or the statistic calculated from the frequency distribution, as the attribute information on the target, from reference information in which attribute information is associated with a plurality of frequency distributions or a plurality of statistics.

10. The information acquisition apparatus according to claim 8, wherein the attribute includes a material.

11. The information acquisition apparatus according to claim 8, wherein the attribute includes at least one of a reflectance, a refractive index, a transmittance, an attenuation coefficient, an absorption coefficient, and a cross section.

12. An information acquisition method comprising:
acquiring a plurality of distance indexes, the distance indexes being based on time differences between emission of light and detection of the light reflected by a target; and
generating distance information regarding a distance to the target based on a frequency distribution of the acquired distance indexes or a statistic calculated from the frequency distribution.

13. A non-transitory computer readable medium including computer executable instructions, wherein the instructions, when executed by a processor, cause the processor to perform a method comprising:
acquiring a plurality of distance indexes, the distance indexes being based on time differences between emission of light and detection of the light reflected by a target; and
generating distance information regarding a distance to the target based on a frequency distribution of the acquired distance indexes or a statistic calculated from the frequency distribution.
